(19) United States
(12) Patent Application Publication
(10) Pub. No.: US 2005/0261420 A1
(43) Pub. Date: Nov. 24, 2005

(54) Method for producing a coating and composition for crosslinkable coatings

(76) Inventors: Jean-Marie Bernard, Mornant (FR); Corinne Varron, Lyon (FR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/468,904

(22) PCT Filed: Mar. 4, 2002
(86) PCT No.: PCT/FR02/00775

§ 371 Date: Jan. 5, 2004

(30) Foreign Application Priority Data
Mar. 2, 2001 (FR) 01/02912

(51) Int. Cl. C08L 75/00

(52) U.S. Cl. 524/589

(57) ABSTRACT

The invention concerns a method for producing a coating having high hardness, impact resistance and chemical attack resistance, characterised in that it consists in: applying on a substrate, simultaneously or successively: A) a polymer composition containing hydroxyl groups; B) an amine-formaldehyde type resin composition; C) a polyisocyanate composition containing at least 30 mol % of compounds comprising at least a biuret group; D) optionally the usual additives; and heating said substrate to a temperature enabling said constituents to be crosslinked.

The invention relates to crosslinkable coatings based on polymers comprising hydroxyl groups and on crosslinking agents based on polyisocyanates and amine-formaldehyde resins.

Polyurethane coatings obtained by crosslinking between the hydroxyl functional groups of the polyol and the isocyanate functional groups of a polyisocyanate oligomer are widely used for their hardness, durability, chemical resistance and impact strength properties.

Coating compositions are also known in which the crosslinking agent is formed by amine-formaldehyde resins that react with the hydroxyl functional groups of the polyol in order to form a network. However, the mechanical properties of the coatings obtained are often unsatisfactory. In addition, these coatings have a tendency to be sensitive to the curing temperature, and this is not without application problems.

Moreover, FR 2 322 911 teaches compositions for curable varnishes comprising a blend of polymers containing hydroxyl groups, of amine-formaldehyde-type resins and of polyisocyanates, in which compositions the polyisocyanate may include compounds having a biuret group. However, the varnishes obtained have an unsatisfactory hardness.

The object of the invention is to provide coating compositions, especially paints or varnishes, that have a high hardness.

Another object of the invention is to provide coatings that have a high flexibility.

Another object of the invention is to provide coatings that have a high impact strength.

Another object is to provide coatings that have higher resistance to chemicals; more precisely, coatings that have a resistance with a rating of 3 or better (i.e. a rating of 3, 2, 1 or 0), for each of the attacks below:
Sulfuric acid attack;
acetic acid attack;
aqueous ammonia attack;
ethanol attack; and
butanone attack
   (the rating system will be detailed later in the description and in the examples).

Another object is to provide coatings and precursor binder compositions that have a resistance to butanone attack with a rating of 2 or preferably better (a resistance with a rating of better than 2 corresponding to a rating of less than 2).

Yet another object is to provide coating compositions that have a long pot life and can be processed in one-component systems called “1K” systems, i.e. in which all of the coating components, especially the crosslinkable compounds, are present in one and the same system.

The subject of the invention is a method for producing a coating having a high hardness, a high impact strength and a high resistance to chemical attack, characterized in that it comprises the application, to a substrate, of a blend, for simultaneous or successive addition, comprising:
A) a composition of a polymer containing hydroxyl groups;
B) an amine-formaldehyde-type resin composition;
C) a polyisocyanate composition containing at least 30 mol % of compounds that include at least one biuret group and the isocyanate functional groups of which are free or temporarily blocked;
D) optionally, standard additives; and the heating of said substrate to a temperature allowing said components to be crosslinked.

The term “high hardness” is understood within the invention to mean a hardness of greater than 200 s (Persoz hardness), as measured one hour after the coating has been cured (minimum cure: 30 minutes at 140° C.).

The term “high impact strength” is understood to mean a strength of greater than 8 (Erichsen cupping).

Surprisingly, the inventors have furthermore discovered that coatings having the aforementioned properties could be obtained when, as crosslinking agent, a polyisocyanate composition is used in which at least some of the isocyanate groups are blocked by a blocking agent, the blocking agent, upon its release from the isocyanate group, reacting completely or partly with the amine-formaldehyde resin and thus participating in the formation of the network without causing defects in the coating film after the latter has been cured, and while limiting the amount of VOCs (volatile organic compounds).

It is advantageous for at least 10 mol %, advantageously 20 mol %, preferably at least 50 mol % and up to 100 mol % of the isocyanate functional groups to be blocked by a blocking agent or a mixture of blocking agents, these preferably being monofunctional.

Component (A) is advantageously a polyol having a hydroxyl content of between 1 and 5 g/l 00 g, advantageously between 3.5 and 4.5 g/100 g, expressed with respect to the solids content.

For this purpose, it is possible to use polyacrylates containing hydroxyl groups, polyesters or alkyds, or mixtures thereof. Most particularly preferred are polyacrylates containing hydroxyl groups, the molecular weight M, of which ranging from 3 000 to 50 000, advantageously from 5 000 to 30 000. It is also preferable for the molecular weight M, to range from 2 000 to 20 000, preferably from 3 000 to 10 000.

The molecular weight (Mw) is measured by gas chromatography (GC), polystyrene being used as reference. This method makes it possible at the same time to obtain Mw (weight-average molecular weight) and Mn (number-average molecular weight). The elution solvent is tetrahydrofuran (THF).

These polyols are as described on pages 40 to 49 of “Waterborne & Solvent based surface coating resins and their application”, Vol. III; John Wiley & Sons, (1998).

The polyol polymer is generally dissolved in an organic solvent. As solvent, mention may be made in particular of esters, aromatic hydrocarbons, ethers, ether esters or amides. It is also possible to use aqueous solutions, emulsions or dispersions of polyols or aqueous-organic formulations.

According to one advantageous embodiment of the present invention, the polyol may be a polyol with a high solids content (SC), the SC of which is between 60 and 100%.

Constituent A is advantageously present in the compositions according to the invention with a solids content of between 10 and 60%, advantageously 20 and 40%, with respect to the total weight of components (A), (B), (C) and (D).

Constituent B is a resin of the amine-formaldehyde type, preferably an at least partially etherified precondensate of formaldehyde and of melamine or of urea. Solvent-free liquid products may be used for the purpose of applying varnishes or paints with a high solids content. However, it is preferred to use the standard amine-formaldehyde resins that contain solvents or aqueous or aqueous-organic solutions, dispersions or emulsions. As amines, it is possible to use triazines, triazoles, diazines, guanidines or guanamines, for example N,N′-dimethylurea, acetylenediurea, dicyanamide, benzoguanamine or alkyl-substituted melamines.

At least some, preferably all, of all the hydroxyl functional groups of the amine-formaldehyde precondensates are etherified. These mixed ether functional groups therefore carry, on one side, the chain of the precondensate and, on the other side, a hydrocarbon chain. This hydrocarbon chain is advantageously connected to said ether functional group via a carbon of sp³ hybridization; advantageously, they have at most 10 carbon atoms, preferably at most 5 carbon atoms. As hydrocarbon chains, mention may especially be made of methyl, ethyl, propyls, butyls (especially n-butyl) or benzyl.

The amine-formaldehyde resin is prepared in a known manner by acid-catalyzed condensation, aqueous formaldehyde preferably being used. Details may be found, for example, in the work by Houben-Weyl, “Methoden der Organischen Chemie” [Methods of Organic Chemistry], (1963), Volume 14/2, pages 319 et seq.

It is preferable for said amine-formaldehyde precondensates to be produced with an excess (generally a slight excess) of formaldehyde, thereby making it possible in particular to maximize the hydroxyl functional end groups. In general, the residual formaldehyde after condensation lies within the range from 1 per thousand to 2 percent by mass of the precondensate.

Thus, one particularly preferred melamine-formaldehyde resin is a resin having a functionality of at least 6, a dynamic viscosity (DIN 53177, 23° C.) of 500 to 2 500 mPa·s, a compatibility with n-heptane of between 2.0 and 5.0 ml/g, a free formaldehyde content of less than 1% and a density of about 1 g/mL.

Mention may be most particularly made of the resins sold by Vianova Resins, now Solutia, under the name MAPRENAL®.

Component (B) is advantageously used with a solids content of between 1 and 40%, advantageously 3 and 20%, by weight with respect to the total weight of components (A), (B), (C) and (D).

Component (B) is generally dissolved in an organic solvent, especially an alcohol.

Component (C) is a polyisocyanate composition comprising at least 30%, advantageously at least 50% by weight, preferably at least 60% by weight, of polyisocyanates that include at least one biuret group.

Advantageously, the polyisocyanate composition is obtained from polycondensation, advantageously catalytic double condensation or triple condensation, of initial isocyanate monomers in the presence of water, an alcohol or an amine.

The polyisocyanate composition may contain polyisocyanates the number of isocyanate functional groups (NCO) per molecule of which is greater than or equal to 2, such as 4-isocyanatomethyl-1,8-diisocyanato-octamethylene or the isocyanatoethyl ester of lysine diisocyanate.

The polyisocyanate composition advantageously contains at least 15% by weight of a compound of formula (I): 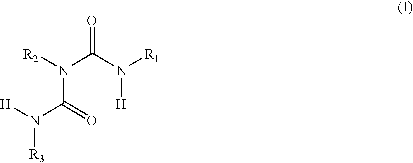
in which R₁, R₂ and R₃, which are identical or different, represent a hydrogen atom, a linear, branched or cyclic C₁-C₂₀ hydrocarbon chain that is optionally substituted, preferably substituted with one or two isocyanate functional groups and/or optionally with a group derived from an isocyanate functional group, namely a carbamate, allophanate, isocyanurate, uretidione, iminooxadiazinedione or oxadiazinetrione group, with the proviso that at most only one of R₁, R₂ and R₃ represents a hydrogen atom.

The composition according to the invention advantageously comprises at least 15%, advantageously at least 30% and preferably at least 50% by weight of compounds of formula (I), in which R₁, R₂ and R₃, which are identical or different, are linear, branched or cyclic C₁-C₂₀ hydrocarbon chains that advantageously include an isocyanate functional group. These compounds are also called “true biurets”.

The polyisocyanate composition of the invention also advantageously contains from 10 to 70%, preferably 15 to 60%, by weight of compounds that include more than one biuret group, namely compounds of general formula (I) in which at least one of R₁, R₂ and R₃ comprises a biuret group of formula:

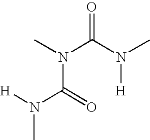

The polyisocyanate composition of the invention furthermore advantageously comprises from 0 to 80%, preferably from 0 to 50%, by weight of isocyanurate compounds that include one or more isocyanurate rings.

Advantageously, the polyisocyanate composition contains from 0 to 50%, preferably from 0 to 30%, by weight of monoisocyanurate compounds.

The polyisocyanate composition furthermore contains:
from 0 to 50%, advantageously from 0.5 to 30%, by weight of compounds having a mono-uretidione group;
from 0 to 50%, advantageously from 0 to 30%, by weight of compounds having an allophanate group;
from 0 to 30%, advantageously from 0 to 5%, by weight of monomers that have not reacted.

The content of isocyanate monomers depends on the volatility of the latter. It is preferable to work with a low monomer content (advantageously at most 1% by mass) when these monomers are volatile.

When it is desired not to work with low isocyanate monomer contents, monomers of very low volatility may therefore be chosen, particularly triisocyanate monomers.

The polyisocyanate compositions of the invention may be obtained by a method comprising the following steps:
a) polycondensation, preferably tricondensation, of a mixture of initial isocyanate monomers in the presence of a tricondensation catalyst, of a compound chosen from water (water or compounds that release water in the reaction mixture being preferred), an alcohol or an amine, in the presence, or advantageously in the absence, of solvent, under the usual conditions;
b) stopping of the reaction at the desired degree of conversion of the NCO functional groups, generally from 2 to 50%, advantageously from 5 to 40% and preferably from 10 to 30% of the NCO functional groups; and
c) optionally, removal of the unreacted monomers.

Reference may also be made to the methods described in EP-A-0 259 233 or U.S. Pat. No. 5,103,045.

The tricondensation catalyst is advantageously a catalyst for the formation of a biuret functional group and, in particular, moderately strong acids having a pKa of at least 1, advantageously at least 2 (for example, phosphoric or phosphonic acids) and preferably at least 3, or else a carboxylic acid as described in FR 86/12524.

To obtain a blocked polyisocyanate composition, a blocking agent or mixture of blocking agents, these preferably being monofunctional, is added to the reaction mixture, before or during step a), after step b) or after step c), in an amount corresponding to the proportion of isocyanate functional groups that it is desired to block, and the reactants are left to react under the reaction conditions for reaction between the isocyanate functional group and the reactive hydrogen of the blocking agent according to the scheme:
Am—H+ISO—N═C=O→Am—CO—NH—ISO,
ISO being as defined above and Am representing the residue of the blocking agent after removal of the reactive hydrogen.

The most commonly used blocking agents are those cited by M. Wicks in his article “Blocked isocyanates”, Progress in Organic Coatings (1975), Vol. 3, p. 73, their deblocking temperatures advantageously being above 50° C., preferably of about 90° C.

The blocking agents may be divided into three groups:
those whose mobile hydrogen is carried by a chalcogen;
those whose mobile hydrogen is carried by a nitrogen; and
those whose mobile hydrogen is carried by a carbon.

Among those whose mobile hydrogen is carried by a chalcogen (preferably a light chalcogen, namely sulfur and oxygen), those in which the chalcogen is an oxygen are most particularly used. Among the latter, mention may in particular be made of:
products having an >N—OH sequence, such as, for example, oximes (═N—OH) or hydroxyimides ([—CO—]₂N—OH); and
phenols, most particularly those for which the aromatic nucleus is depleted in electrons, such as hydroxypicolines and hydroxybenzoates (for example, EP-A-680 984-and WO 98/4608).

Mention may also be made of the compounds disclosed in application EP-A-0 661 278.

Among those whose mobile hydrogen is carried by a nitrogen, mention may in particular be made of:
monosubstituted amides, and particularly lactams (the most widely used one being caprolactam);
imides ([—CO—]₂N—H), most particularly cyclic imides such as succinimide; and
unsaturated nitrogen heterocycles, especially those with a five-membered ring (advantageously doubly unsaturated), preferably comprising at least two heteroatoms (preferably nitrogen). Among the latter, mention may be made of diazoles (such as glyoxalines, imidazoles and pyrazoles), triazoles, or even tetrazoles, optionally including one or more substituents. This group of blocking agents is particularly preferred. Mention may most particularly be made of pyrazole and its derivatives having one or more substituents, especially alkyl groups, for example 3,5-dimethylpyrazole.

Mention may also be made of the compounds disclosed in application EP-A-0 661 278.

Among those whose mobile hydrogen is carried by a carbon, mention may essentially be made of compounds of malonic nature, that is to say an RCH< radical carrying two electron-withdrawing groups (such as carbonyl, nitrile, Rf or perfluoroalkyl).

In this regard, mention may especially be made of the following pairs of blocking agents: methyl amyl ketoxime/2-hydroxypyridine and dimethylpyrazole/2-hydroxypyridine.

The present invention is not limited to the nature of the isocyanate monomers employed. Thus, the isocyanate monomers may be aliphatic, including cycloaliphatic, diisocyanates or triisocyanates, such as:
polymethylene diisocyanates, and especially hexamethylene diisocyanate (HDI), 2-methylpentamethylene diisocyanate, 4-isocyanato-methyloctamethylene diisocyanate and 2,4,4-trimethylhexamethylene diisocyanate;
isophorone diisocyanate (IPDI), norbornane diisocyanate (NBDI), 1,3-bis(isocyanatomethyl)cyclohexane (BIC), 4,4′-diisocyanatodicyclohexyl-methane (H₁₂-MDI) and cyclohexyl-1,4-diisocyanate (CHDI).

The preferred isocyanates according to the invention are those in which at least one, advantageously two and preferably three of the above conditions are fulfilled:
at least one, advantageously two, of the NCO functional groups are linked to a hydrocarbon backbone via a saturated carbon (sp³);
at least one, advantageously two, of said saturated (Sp³) carbons carries at least one, advantageously two, hydrogen(s). In other words, it has been found that better results are obtained when the carbon carrying the isocyanate functional group carries a hydrogen, preferably two hydrogens; it is also preferable for said saturated (sp³) carbons to even be, at least in the case of one third, advantageously at least in the case of one half and preferably at least in the case of two thirds of them, linked to the backbone via a carbon atom that itself carries at least one hydrogen, more preferably two hydrogens; and
all the intermediate carbons from which the isocyanate functional groups are linked to the hydrocarbon backbone are saturated (sp³) carbons, advantageously some, preferably all, of which carry a hydrogen, preferably two hydrogens. It is furthermore even preferable for said saturated (sp³) carbons to be, at least in the case of one third, advantageously at least in the case of one half and preferably at least in the case of two thirds of them, linked to said backbone via a carbon atom that itself carries at least one hydrogen, more preferably two hydrogens.

In general, the preferred initial isocyanates (monomers) are those having at least one polymethylene chain sequence (comprising from 2 to 6 methylene chain links).

Isocyanates, particularly aliphatic diisocyanates, especially C₁-C₁₀ alkyl isocyanates, are preferred in which the alkyl chain is linear or lightly branched. The term “lightly branched” is understood to mean the absence of any tertiary and/or neopentyl carbon.

HDI, IPDI, NBDI, H₁₂MDI and MPDI are particularly preferred.

Component (C) is generally diluted in a solvent, so that the solids content of the composition is between 60 and 75% by weight.

Component (D) may be chosen from one of more of the following compounds: cellulose esters, spreading agents, plasticizers, silicone oils, thixotropic agents, wetting agents and mar-resistance agents, pigments or fillers, for example titanium dioxide, carbon black, organic or mineral colored pigments, talc or barium sulfate, crosslinking catalysts, UV stabilizers, etc.

Examples of suitable catalysts are, on the one hand, sulfonic acids, especially methanesulfonic acids or trifluoromethanesulfonic acids, for example para-toluenesulfonic acid, and, on the other hand, certain tin compounds, such as dibutyltin dilaurate or latent forms of these compounds, such as salts of para-toluenesulfonic acid, methanesulfonic acid or perfluoroalkanesulfonic acids.

It is also possible to use latent forms of these catalysts, such as the amine salts of these strong acids.

The crosslinking catalysts are present in a proportion ranging from 0 to 3%, preferably from 0 to 1%, by weight.

Component (D) may be contained in the proportions of 0 to 65%, preferably 0 to 50%, by weight.

Advantageously, the ratio of isocyanate functional groups to hydroxyl functional groups is less than 3, advantageously less than 2 and preferably between 0.3 and 1.5.

The subject of the invention is also a coating composition, characterized in that it comprises:
A) from 20 to 50% by weight of solids content of a polymer containing hydroxyl groups;
B), from 3 to 20% by weight of solids content of a resin of the amine-formaldehyde type;
C) from 5 to 20% by weight of solids content of a polyisocyanate composition containing at least 50 mol % of one or more biuret group(s), in which at least 10%, advantageously at least 20% and preferably at least 50% of the isocyanate groups are protected using a monofunctional blocking agent;
D) from 0 to 30% by weight of solids content of various coating additives; and
E) from 10 to 20% by weight of solvents.

Components (A), (B), (C) and (D) are as defined above. Component (E) furthermore comprises the solvents described above for the formulation of components (A) and (B), optionally one or more other solvents for the formulation of the final coating composition, n-butyl acetate, ethylene glycol acetate, methyl ethyl ketone or xylene.

The examples below illustrate the invention without however limiting it.

### EXAMPLE 1

### Coating Formulation

The following ingredients were mixed in order and homogenized:

| | | Compound 2 |
|---|---|---|
| | Compound 1 | (comparative) |
| VIACRYL SC 370/75 SNA* | 50.35 | 50.35 |
| n-BUTANOL | 3.50 | 3.50 |
| SOLVESSO 150 | 7.00 | 7.00 |
| SOLVESSO 100 | 9.10 | 9.10 |
| MAPRENAL VMF 3611/70B** | 23.15 | — |
| XYLENE/BUTANOL (7/3) | 5.30 | 5.30 |

*polyol:SC = 75%; dry OH = 3.64%;
**melamine-formaldehyde resin.

Various varnish formulations were prepared by adding to compound 1 or to compound 2 a polyisocyanate composition 1 (PIC 1) containing 100% isocyanate functional groups blocked by 3,5-dimethylpyrazole (3,5-DMP) having the following composition before blocking:

| | % by weight |
|---|---|
| PIC 1 composition | (solids content) |
| Residual HDI | 0.25 |
| HDI dimer | 2.46 |
| HDI biuret | 33.0 |
| HDI bis(biuret) | 17.7 |
| Heavy [tris(biuret)] fractions | 21.6 |

At the same time, varnish formulations (comparative example) were prepared by adding, to compounds 1 and 2 above, a polyisocyanate composition PIC 2 having an identical composition except that the biuret was replaced with isocyanurate in the HDI biuret, the HDI bis(biuret) and the heavy fractions.

| VARNISH FORMULATIONS | | | | |
|---|---|---|---|---|
| SC = 48% | | | | |
| NCO/OH | 1.05 | 1.05 | 1.05 | 1.05 |
| Compound 1 | 50 | 50 | — | — |
| Compound 2 | — | — | 40 | 40 |
| (comp.) | | | | |
| 1% PTSA | 2.40 | 2.40 | 1.92 | 1.92 |
| Xylene | 3.83 | 1.94 | 5.84 | 4.33 |
| PIC 2 | 9.05 | — | 7.24 | — |
| PIC 1 | — | 10.80 | — | 8.64 |

### EXAMPLE 2

### Properties of the Coatings Obtained with the Compositions Of the Invention

The above varnish compositions were applied to glass or steel substrates using a 100 μm spiral filmograph in the case of the steel substrate and in the case of the glass plates.

After 30 minutes of desolvation, the compositions were cured at 140° C. and 150° C. for 30 minutes.

After 7 days at room temperature, the following properties were measured:
hardness (Persoz);
flexibility;

impact strength.

TABLE I
Persoz hardness on a glass plate

| | |
|---|---|
| | Compound 2 |
| Compound 1 | (comp.) |

| | | PIC 2 | PIC 1 | PIC 2 | PIC 1 |
|---|---|---|---|---|---|
| | NCO/OH | 1.05 | 1.05 | 1.05 | 1.05 |
| T0 + 1 h | 140° C. | 279 | 322 | 353 | 317 |
| | 150° C. | 337 | 357 | | |
| T0 + 48 h | 140° C. | 303 | 331 | 350 | 321 |
| | 150° C. | 361 | 365 | | |
| T0 + 7 d | 140° C. | 321 | 330 | 351 | 321 |
| | 150° C. | 358 | 366 | | |

TABLE II
Persoz hardness on R46 steel plate

| | |
|---|---|
| | Compound 2 |
| Compound 1 | (comp.) |

| | | PIC 2 | PIC 1 | PIC 2 | PIC 1 |
|---|---|---|---|---|---|
| | NCO/OH | 1.05 | 1.05 | 1.05 | 1.05 |
| T0 + 1 h | 140° C. | 244 | 263 | 273 | 268 |
| | 150° C. | | 291 | | |
| T0 + 48 h | 140° C. | 257 | 274 | 288 | 273 |
| | 150° C. | | 299 | | |
| T0 + 7 d | 140° C. | 249 | 271 | 284 | 270 |
| | 150° C. | | 301 | | |

TABLE III
Flexibility tests on R46 steel plates

| | | | | Compound 2 | |
|---|---|---|---|---|---|
| | | Compound 1 | | (comp.) | |
| | | PIC 2 | PIC 1 | PIC 2 | PIC 1 |
| | NCO/OH | 1.05 | 1.05 | 1.05 | 1.05 |
| Thickness (μm) | 140° C. | 39 | 40 | 29 | 32 |
| | 150° C. | | 39 | | |
| Erichsen cup test* | 140° C. | 8.4 | 8.3 | 8.1 | 8.5 |
| | 150° C. | | 8.0 | | |
| Impact test | AFNOR | 15 | 25 | 5 | 15 |
| | ASTM | 24 | 14 | 6 | 8 |
| Impact test | AFNOR | 20 | 50 | <5 | 5 |
| | ASTM | 18 | 46 | <4 | 8 |
| Cross-cutting test | 30 min | 0 | 0 | 0 | 0 |
| | 140° C. | | | | |

*Values greater than or equal to “9” were not to be considered as the piston of the cup passed through the plate.

TABLE IV
Chemical resistance

| | Compound 1 | Compound 2 |
|---|---|---|
| Hardener | PIC 1 | PIC 1 |
| 30 min at 140° C. | | |
| NCO/OH | 1.05 | 1.05 |
| 25% acetic acid, 1 h | 0-1 | 5 |
| 10% sulfuric acid, 1 h | 1- | 5 |
| 10% aqueous ammonia, 1 h | 1- | 1- |
| Ethanol, 1 h | 1 | 1- |
| MEK, 3 min | 1 | 1 |
| 30 min at 150° C. | | |
| NCO/OH | 1.05 | 1.05 |
| 25% acetic acid, 1 h | 1- | 5 |
| 10% sulfuric acid, 1 h | 0 | 5 |
| 10% aqueous ammonia, 1 h | 1- | 1 |
| Ethanol, 1 h | 1 | 1 |
| MEK, 3 min | 1 | 4 |

Ratings 0 to 5:
0: the film is not attacked and the solvent leaves no trace;
1: the film is very slightly attacked after evaporation of the solvent; a mark is observed around the perimeter of the drop. The inner part is identical to the rest of the film in appearance and to the touch (after complete evaporation, the film is slightly tacky to touch).
2: the film is attacked after evaporation of the solvent; it is observed that the position of the drop is blurred and that the film is tacky even after evaporation of the solvent;
3: the film is wrinkled, a sign that crosslinking is neither complete nor uniform;
4: the film is dissolved after evaporation of the solvent; a rim is observed around the periphery of the drop. Inside, the film is sticky to touch and has no cohesion;
5: the substrate is seen after evaporation of the solvent; a rim is observed around the periphery of the drop. Inside, the film is destroyed and the substrate can be seen.

It is clearly apparent that the results obtained with composition 1 are superior to the results obtained with composition 2.

For compounds without the amine-formaldehyde resin, the isocyanate-based compositions (PIC 2) give better results, whereas when a melamine-formaldehyde resin is used the compositions containing biuret give, in all cases, results that are at least as good and are often better.

1. A method for producing a coating having a high hardness, a high impact strength and a high resistance to chemical attack, which comprises the application, to a substrate, of a blend for simultaneous or successive addition, comprising:
A) a composition of a polymer containing hydroxyl groups;
B) an amine-formaldehyde-type resin composition;
C) a polyisocyanate that include containing at least 30 mol % of compounds that include at least one biuret group; and
D) optionally, standard additives; and the heating of said substrate to a temperature allowing said components to be crosslinked.

2. The method as claimed in claim 1, wherein at least 10 mol % of the isocyanate functional groups are blocked by a monofunctional blocking agent.

3. The method as claimed in claim 1, wherein the blocking agent comprises heterocyclic nitrogen compounds.

4. The method as claimed in claim 3, wherein the blocking agent is a pyrazole, optionally substituted with one or more substituents.

5. The method as claimed in claim 4, wherein the blocking agent is 3,5-dimethylpyrazole.

6. The method as claimed in claim 1, wherein polymer (A) is an acrylic polyol having a hydroxyl content of between 1 and 5 g/100 g of polymer solids content.

7. The method as claimed in claim 1, wherein polymer (A) is an acrylic polyol having a molecular weight of between 1 000 and 5 000.

8. The method as claimed in claim 1, wherein constituent (B) is a melamine-formaldehyde resin.

9. The method as claimed in claim 1, wherein component (C) is the product obtained from polycondensation of an aliphatic or cycloaliphatic diisocyanate or triisocyanate.

10. The method as claimed in claim 7, wherein component (C) is the product obtained from polycondensation of a diisocyanate.

11. The method as claimed in claim 1, wherein the solids content of component (A) is between 10 and 60% with respect to the weight of components (A), (B), (C) and (D).

12. The method as claimed in claim 1, wherein the solids content of component (D) is between 0 and 65% with respect to the weight of components (A), (B), (C) and (D).

13. The method as claimed in claim 1, wherein component (C) comprises at least 50% of polyisocyanate compounds that include at least one biuret group with respect to the total weight of the polyisocyanate compounds.

14. The method as claimed in claim 1, wherein component (C) comprises at least 15% by weight of compounds of formula (I): 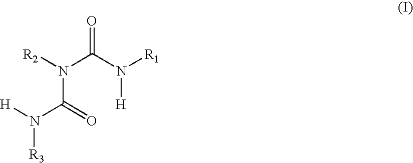
in which R₁, R₂ and R₃, which are identical or different, are linear, branched or cyclic C₁-C₂₀ hydrocarbon chains that optionally comprise an isocyanate functional group.

15. The method as claimed in claim 1, wherein the ratio of isocyanate functional groups to hydroxyl functional groups is less than 3.

16. A coating composition, which comprises:
A) from 20 to 50% by weight of solids content of a polymer containing hydroxyl groups;
B) from 3 to 20% by weight of solids content of a resin of the amine-formaldehyde type;
C) from 5 to 20% by weight of solids content of a polyisocyanate composition comprising at least 50 mol % of one or more biuret groups, in which at least 10 mol % of the isocyanate groups are protected using a monofunctional blocking agent;
D) from 0 to 30% by weight of solids content of various additives for the coating; and
E) from 10 to 20% by weight of one or more solvents.

17. The composition as claimed in claim 16, wherein the blocking agent comprises heterocyclic nitrogen compounds.

18. The composition as claimed in claim 16, wherein the blocking agent is a pyrazole optionally substituted with one or more substituents.

19. The composition as claimed in claim 16, wherein the blocking agent is 3,5-dimethylpyrazole.

20. The composition as claimed in claim 16, wherein polymer (A) is an acrylic polyol having a hydroxyl content of between 1 and 5 g/100 g of polymer solids content.

21. The composition as claimed in claim 16, wherein polymer (A) is an acrylic polyol having a molecular weight of between 30 000 and 5 000.

22. The composition as claimed in claim 16, wherein component (B) is a melamine-formaldehyde resin.

23. The composition as claimed in claim 16, wherein component (C) is the product obtained from polycondensation of an aliphatic or cycloaliphatic diisocyanate or triisocyanate.

24. The composition as claimed in claim 23, wherein component (C) is the product obtained from polycondensation of a diisocyanate.

25. The composition as claimed in claim 16, wherein component (C) comprises at least 50% of polyisocyanate compounds that include at least one biuret group with respect to the total weight of the polyisocyanate compounds.

26. The composition as claimed in claim 16, wherein component (C) comprises at least 15% by weight of compounds of formula (I): 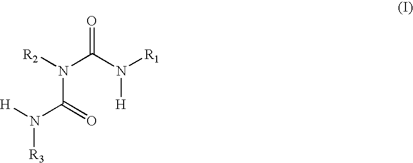
in which R₁, R₂ and R₃, which are identical or different, are linear, branched or cyclic C₁-C₂₀ hydrocarbon chains that optionally comprises an isocyanate functional group.

27. The composition as claimed in claim 16, wherein the ratio of isocyanate functional groups to hydroxyl functional groups is less than 3.
